(19) United States
(12) Patent Application Publication
(10) Pub. No.: US 2025/0352964 A1
(43) Pub. Date: Nov. 20, 2025

(54) METHOD OF MANUFACTURING A CENTRIFUGAL WHEEL

(71) Applicant: Levitronix GmbH, Zürich (CH)

(72) Inventors: Thomas Nussbaumer, Zürich (CH); Thomas Schneeberger, Bern (CH)

(21) Appl. No.: 19/207,509

(22) Filed: May 14, 2025

(30) Foreign Application Priority Data
May 14, 2024 (EP) 24175815.0

(51) Int. Cl. B01F 33/453; F04D 13/02

(52) U.S. Cl. CPC B01F 33/453; F04D 13/024; F05B 2260/4041

(57) ABSTRACT

A method of manufacturing a centrifugal wheel for a mixing or pumping device with a magnetically levitated centrifugal wheel, includes providing an impeller configured to be magnetically levitated, has and having a permanent magnetic core, permanent magnetic core completely enclosed by a sheathing, the sheathing including plastic, and a plurality of blades to mix or convey substances provided on the sheathing, removing all blades from the sheathing, separating the permanent magnetic core from the sheathing, the permanent magnetic core being demagnetized before the permanent magnetic core is separated from the sheathing, attaching an encapsulation including plastic, and which completely encloses the permanent magnetic core, and attaching a plurality of vanes to the encapsulation.

### CROSS-REFERENCE TO RELATED APPLICATION

This application claims priority to EP Application Serial No. 24175815.0, filed on May 14, 2024, the contents of which are hereby incorporated by reference.

### BACKGROUND

### Technical Field

The disclosure relates to method for manufacturing a centrifugal wheel for a mixing or pumping device with a magnetically levitated centrifugal wheel.

### Background Information

In the biotechnological and pharmaceutical industries, electromagnetic rotary drives are frequently used which are designed as pumping devices or as mixing devices in which the rotor, which forms the centrifugal wheel, is magnetically supported. For example, the pumping devices, e.g. centrifugal pumps, serve to convey fluids through a circuit with a bioreactor. The mixing devices are used, for example, to prepare buffer solutions or cell culture media, or also for continuous mixing and circulation of the nutrient liquid in a bioreactor.

In the pharmaceutical industry, in the production of pharmaceutically effective substances, very high demands must be placed on purity, the components which come into contact with the substances often even have to be sterile. Similar demands also result in biotechnological, for example in the production, treatment or cultivation of biological substances, cells, or microorganisms, where an extremely high degree of purity has to be ensured in order not to endanger the usability of the product produced.

In order to meet the purity requirements for the process as well as possible, efforts are made to keep the number of components of a pumping or mixing device which come into contact with the respective substances as small as possible. For this purpose, electromagnetically operated pumping or mixing devices are known in which the rotor, which usually forms the centrifugal wheel, is arranged in the mixing container. Then, a stator is provided outside the mixing container, which drives the rotor without contact through the wall of the mixing container and magnetically supports it without contact in a desired position by magnetic or electromagnetic fields. This “contactless” concept particularly also has the advantage that no mechanical bearings or feedthroughs into the mixing container are required, which can be a cause of impurities or contaminations.

A particularly efficient device of this type, with which substances are circulated or mixed in a bioreactor, is disclosed in EP 3 115 103 A1, for example. Here, the stator and the rotor arranged in the mixing container, which rotor forms the centrifugal wheel, form a bearingless motor. The term bearingless motor means an electromagnetic rotary drive in which the rotor is supported completely magnetically with respect to the stator, wherein no separate magnetic bearings are provided. For this purpose, the stator is designed as a bearing and drive stator, which is both the stator of the electric drive and the stator of the magnetic bearing. A magnetic rotating field can be generated with the electric windings of the stator, which on the one hand exerts a torque on the rotor, which causes its rotation and which, on the other hand, exerts an arbitrarily adjustable transverse force on the rotor, so that its radial position can be actively controlled or regulated.

The rotor of this mixing device is an integral rotor because it is both the rotor of the electromagnetic drive and the centrifugal wheel of the mixing device. In addition to the contactless magnetic bearing, the bearingless motor also offers the advantage of a very compact and space-saving design.

### SUMMARY

Although the number of components that come into contact with the substances can be greatly reduced with such non-contact magnetically supported mixers, it has been determined that the cleaning and sterilization of these components is still associated with a very large expenditure of time, material and costs. Therefore, it is often the case—as also disclosed in the already cited EP 3 115 103 A1—that the components that come into contact with the substances are designed as single-use parts for single use. Such a mixing device is then composed of a single-use device and a reusable device. The single-use device comprises those components which are intended for single use, i.e., for example the mixing container with the rotor, and the reusable device comprises those components which are used permanently, i.e., multiple times, for example the stator.

The term single-use parts designates parts or components that can only be used once in accordance with their intended purpose. After use, the single-use parts are disposed of and replaced for the next application by new, i.e., not yet used, single-use parts.

In a schematic view, FIG. 1 shows a mixer or a bioreactor 100′ as known from the state of the art.

To indicate that the representation in FIG. 1 is a device from the state of the art, the reference signs are each marked here with an inverted comma or with a dash. The bioreactor 100′ comprises a mixing container 110′ that is designed as a single-use part. When designed as a single-use part, the mixing container 110′ is often designed as a flexible plastic bag arranged in a dimensionally stable and reusable support container 120′. The support container 120′ is made of stainless steel or designed as a dimensionally stable plastic part, for example.

The mixing container 110′ designed as a plastic bag is filled with a fluid F′, for example with a medium, a buffer solution or a cell broth. The mixing container 110′ comprises a dimensionally stable base plate 111′ with a cylindrical cup 112′ for receiving a centrifugal wheel 1′. The centrifugal wheel 1′ forms the rotor of a mixing device and comprises a permanent magnetic core (not visible in FIG. 1), which is completely enclosed by a sheathing 30′, wherein the sheathing 30′ consists of a plastic. A plurality of blades 20′ for mixing the fluid F′ is provided on the sheathing 30′. In the operating state, the permanent magnetic core of the centrifugal wheel 1′ is arranged in the cylindrical cup 112′.

The mixing device further comprises a stator 130′ which, together with the centrifugal wheel 1′, forms an electromagnetic rotary drive which is designed according to the principle of the bearingless motor. Thus, the stator 130′ is designed as a bearing and drive stator, with which the centrifugal wheel 1′ can be magnetically driven without contact in the operating state for rotation about a desired axis of rotation and can be magnetically supported without contact with respect to the stator 130′. The desired axis of rotation defines an axial direction A.

In FIG. 1, the stator 130′ is represented with a cutout so that the arrangement of the centrifugal wheel 1′ in the stator 130′ can be better recognized. The stator 130′, which is arranged outside the mixing container 110′, comprises a cup-shaped recess into which the cylindrical cup 112′ of the mixing container 110′ can be inserted so that the centrifugal wheel 1′ can be magnetically supported without contact in the stator 130′.

The mixing container 110′, designed as a flexible plastic bag, with the centrifugal wheel 1′ arranged therein, is designed as a single-use device for single use, while the stator 130′ and the supporting container 120′ are designed as a reusable device for multiple use. After one application, the mixing container 110′ with the centrifugal wheel 1′ located therein is thus removed from the reusable device and disposed of. For the next application, a new, i.e. not yet used, mixing container 110′ with a new, i.e. not yet used, centrifugal wheel 1′, which is arranged in the mixing container 110′, is then inserted into the stator 130′ and the supporting container 120′.

The design of the mixing container 110′ and the centrifugal wheel 1′ as single-use parts has proven to be very advantageous, particularly in the pharmaceutical and biotechnological industries, because it enables a very high degree of flexibility in the various processes. In addition, time-consuming and costly sterilization processes can at least be significantly reduced. Furthermore, the risk of cross-contamination can be significantly reduced.

It is a substantial aspect that the single-use parts can be manufactured as economically and cost-effectively as possible. Here, particular emphasis is placed on low-cost, simple starting materials, such as commercially available plastics. Sustainability, an environmentally conscious handling and a responsible use of the available resources are also substantial aspects in the design of single-use parts. The disclosure is dedicated to these aspects.

It is therefore an object of the disclosure to propose a method of manufacturing a centrifugal wheel for a mixing or pumping device with a magnetically levitated centrifugal wheel that enables a particularly cost-effective, environmentally friendly and sustainable manufacturing of a centrifugal wheel. In particular, the centrifugal wheel should also be able to be designed as a single-use part for single use.

The subject matters of the disclosure meeting these object are characterized by the features of the present disclosure.

According to the disclosure, a method of manufacturing a centrifugal wheel for a mixing or pumping device with a magnetically levitated centrifugal wheel is proposed, comprising the following steps:
Providing an impeller that can be magnetically levitated, which has a permanent magnetic core, which is completely enclosed by a sheathing, wherein the sheathing consists of a plastic, and wherein a plurality of blades for mixing or conveying substances is provided on the sheathing;
Removing all blades from the sheathing;
Separating the permanent magnetic core from the sheathing;
Attaching an encapsulation which consists of a plastic, and which completely encloses the permanent magnetic core;
Attaching a plurality of vanes to the encapsulation.

According to the disclosure, it is thus proposed to separate the permanent magnetic core from an existing impeller, for example an impeller designed as a single-use part and already used, and to use this for the manufacturing of a new centrifugal wheel. In this way, the permanent magnetic core can be reused, even in the case of used single-use parts. Since the permanent magnetic core in the used impeller was protected from a contact with substances by the sheathing, there is no risk that reuse could cause cross-contamination.

Since the permanent magnetic core is usually the most expensive component of the centrifugal wheel, the reuse of the permanent magnetic core leads to a significant cost reduction in the manufacturing of the centrifugal wheel.

According to the present state of the art, it is common to use one or more permanent magnets for the permanent magnetic core of the centrifugal wheel. In particular, rare earth metals or compounds or alloys of these metals are used as permanent magnets because very strong permanent magnetic fields can be generated with them due to their magnetic properties. Well-known and frequently used examples of these rare earths are neodymium and samarium. However, such metals represent a significant cost factor due to the complexity of their extraction and processing. In addition, the disposal of such permanent magnets, for example after single use, is often associated with problems or a high level of effort also from an environmental point of view, which results in additional costs. Therefore, from an economic, cost and environmental point of view, in particular in the case of single-use applications, it is advantageous that the permanent magnetic core of an impeller is used to manufacture a new centrifugal wheel after the impeller has been used. In particular, the CO₂ balance of the centrifugal wheel can be significantly improved by the method according to the disclosure. Reusing the permanent magnetic core to manufacture a new centrifugal wheel is also particularly advantageous from a sustainability aspect.

According to a preferred embodiment, the permanent magnetic core is demagnetized before the permanent magnetic core is separated from the sheathing. In this way, it can be avoided in particular that the permanent magnetic core attracts impurities. Since the permanent magnetic core is completely separated from the sheathing during the method, it can be better ensured, due to the prior demagnetization, that impurities do not attach to the permanent magnetic core.

In the framework of the present application, the term “demagnetization” refers to the reduction of the magnetic moment (dipole moment) of the permanent magnetic core to a value which is at most 10% of the magnetic moment which the permanent magnetic core has when fully magnetized.

Furthermore, various optional processing steps, such as mechanical processing with metallic tools or spraying the permanent magnetic core in an injection molding device, can be carried out more easily if the permanent magnetic core is demagnetized.

Preferably, the permanent magnetic core is magnetized again after the encapsulation has been attached. The magnetization can be carried out immediately after the encapsulation has been attached or also after the vanes have been attached to the encapsulation.

To separate the permanent magnetic core from the sheathing, several variants are possible. For example, the separation of the permanent magnetic core from the sheathing takes place by a mechanical processing.

The mechanical processing comprises cutting or drilling or grinding or milling, for example.

It is a preferred variant that the separation of the permanent magnetic core from the sheathing takes place by a mechanical pressing device. For this purpose, it is possible to press the permanent magnetic core through the sheathing by the pressing device, thereby pushing it out of the sheathing.

If the permanent magnetic core is designed in a ring-shaped manner, it is preferred that a central bore is made to separate the permanent magnetic core from the sheathing, which bore extends completely through the sheathing in an axial direction. Thus, the sheathing is completely drilled through in the axial direction and preferably in the central area of the sheathing, so that a cylindrical opening is created in the center of the sheathing. Subsequently, the sheathing is designed in a ring-shaped manner.

It is a further variant that heat is supplied to the sheathing to separate the permanent magnetic core from the sheathing. In this way, for example, the plastic of which the sheathing is made can be melted or fused to separate the permanent magnetic core from the sheathing. In particular, it is also possible to combine such a thermal process with a mechanical processing to separate the permanent magnetic core from the sheathing. For example, the sheathing can be softened by supplying heat in order to then push the permanent magnetic core out of the sheathing, for example by a pressing device.

According to a preferred way of proceeding, the encapsulation is manufactured by spraying a plastic around the permanent magnetic core. This can take place, for example, in an injection molding process in an injection molding device.

It is a further preferred way of proceeding that the encapsulation and the vanes are manufactured in a single injection molding process. This means that the encapsulation and all the vanes are manufactured together in a single injection molding process. Of course, it is optionally possible that the final shape of the vanes and/or the encapsulation is created after this injection molding process by mechanical finishing, for example by a chip-removing processing.

According to another preferred way of proceeding, the encapsulation is manufactured by joining several components.

For this purpose, it is possible, for example, that the encapsulation comprises a cup and a cover, wherein the permanent magnetic core is inserted into the cup, and wherein the cover is welded to the cup. Thus, the encapsulation is made of two plastic parts, namely the cup, into which the permanent magnetic core is inserted, and the cover, with which the cup is closed. The welding of the cup to the cover can take place by, for example, mirror, ultrasonic or infrared welding. Of course, other joining methods are also possible to connect the cover to the cup, for example gluing or screwing.

A further preferred way of proceeding is to manufacture the encapsulation by a sintering process. The encapsulation is then manufactured from a powder or a granulate which is pressed onto the permanent magnetic core using pressure and, optionally, heat treatment, in such a way that the permanent magnetic core is completely enclosed.

The plurality of vanes, for example, are attached to the encapsulation by welding. Here, it is possible that each vane is attached individually to the encapsulation, for example by welding or gluing, or that a base plate with the vanes arranged and fixed on it is first manufactured, and this base plate is then fixed to the encapsulation.

In particular for applications in the biotechnological or pharmaceutical industry, it is preferred that the encapsulation and the vanes consist of a biocompatible plastic.

For example, the encapsulation and the vanes can consist of polyethylene (PE) or polypropylene (PP).

Further advantageous measures and embodiments of the disclosure are apparent from the present disclosure.

### BRIEF DESCRIPTION OF THE DRAWINGS

In the following, the disclosure will be explained in more detail with reference to embodiments and with reference to the drawing. In the schematic drawing:

FIG. 1 is a schematic view of a bioreactor, which is known from the state of the art,

FIG. 2 is a perspective view of an embodiment of a centrifugal wheel, which is manufactured by a method according to the disclosure,

FIG. 3 is a sectional view of the embodiment from FIG. 2 in a section along the axial direction,

FIG. 4 is a perspective view of a variant for the embodiment of the permanent magnetic core,

FIG. 5 is a schematic sectional view of an impeller, which can be used for a method according to the disclosure,

FIG. 6 is the impeller from FIG. 5 after removing all blades, and

FIG. 7 is a variant for the embodiment of the permanent magnetic core of the impeller.

### DETAILED DESCRIPTION

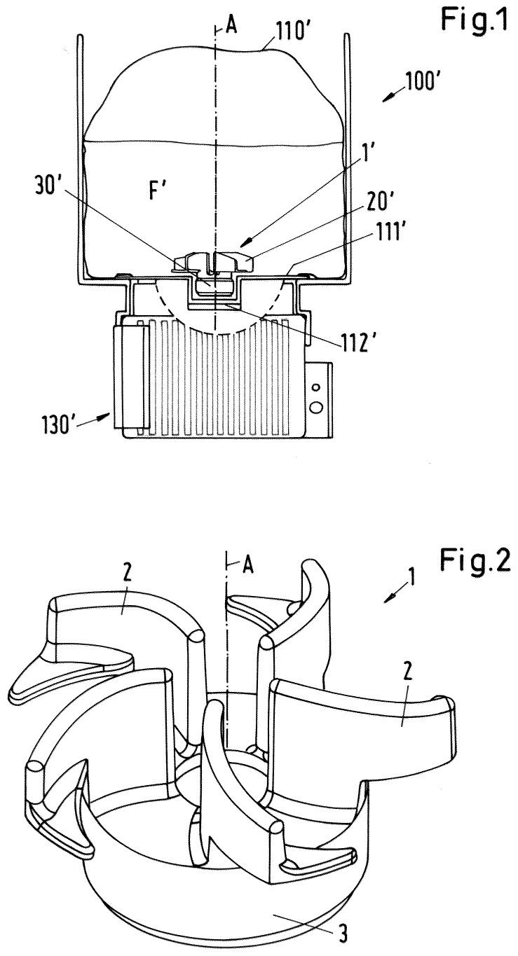

As already explained above, FIG. 1 shows a schematic view of a bioreactor 100′, which is known from the state of the art. The bioreactor 100′ comprises a mixing device with a non-contact magnetically supported and non-contact magnetically driven centrifugal wheel 1′ for mixing at least two substances.

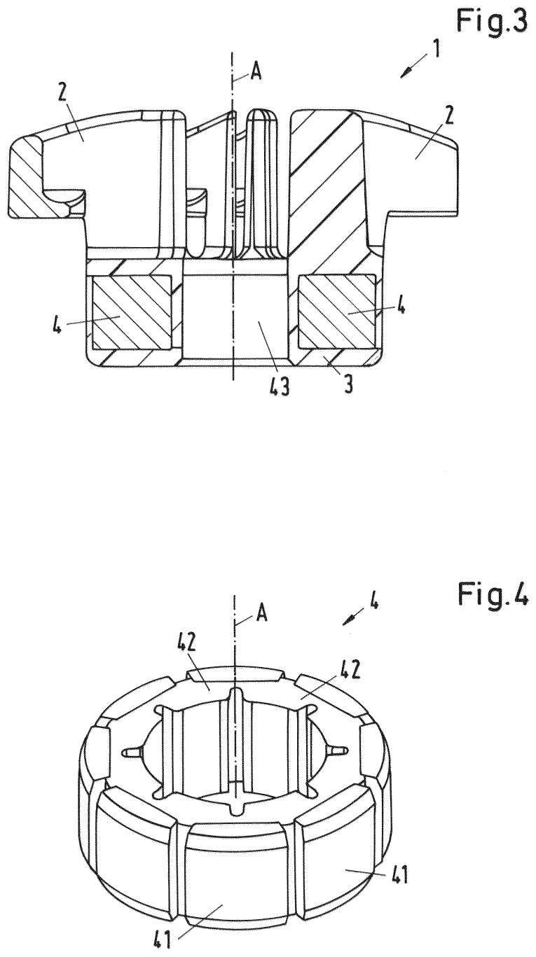

FIG. 2 shows in a perspective view an embodiment of a centrifugal wheel, which is manufactured by a method according to the disclosure. The centrifugal wheel is designated in its entirety with the reference sign 1. The centrifugal wheel 1 is designed for rotation about an axial direction A. For better understanding, FIG. 3 shows the centrifugal wheel 1 from FIG. 2 in a sectional view, wherein the section is made along the axial direction.

The centrifugal wheel 1 is designed for a pumping device for conveying a fluid or for a mixing device for mixing at least two flowable substances. In particular, the centrifugal wheel 1 for such a bioreactor 100′ can be designed with a mixing device, as represented in FIG. 1. The term “flowable substances” comprises, in addition to fluids, in particular also powdery substances. Thus, the mixing device can also be used in particular for mixing a powder and a liquid, for example to dissolve the powder in the liquid.

In particular, the centrifugal wheel 1 is designed for a preferably non-contact magnetic levitation and for a non-contact drive for rotation about the axial direction A. The centrifugal wheel 1 can be inserted, for example, into the stator 130′ (FIG. 1), which is designed as a bearing and drive stator. Then, the centrifugal wheel 1 forms an electromagnetic rotary drive with the stator 130′, wherein the centrifugal wheel 1 can be magnetically driven without contact for rotation about the axial direction A and can be magnetically levitated without contact with respect to the stator 130′ in the operating state

The centrifugal wheel 1 represented in FIG. 2 and FIG. 3 is designed for an electromagnetic rotary drive that is configured as an internal rotor, i.e. the stator 130′ is arranged around the centrifugal wheel. Of course, it is also possible that the centrifugal wheel 1 is designed for an electromagnetic rotary drive that is configured as an external rotor, i.e. the stator is arranged radially inwardly in the centrifugal wheel 1, so that the centrifugal wheel 1 extends in the circumferential direction around the stator. Such a configuration as an external rotor is shown, for example, in FIG. 2 of EP 3 115 103 A1.

The centrifugal wheel 1 comprises a permanent magnetic core 4 and an encapsulation 3, which consists of a plastic, and which completely encloses the permanent magnetic core 4. Due to the encapsulation 3, it is thus ensured that the permanent magnetic core 4 does not come into contact with the conveyed fluid or the substances to be mixed in the operating state.

A plurality of vanes 2 is arranged on the encapsulation 3, which are fixed on the encapsulation 3. In the embodiment represented in FIG. 2 and FIG. 3, exactly five vanes 2 are provided in an exemplary manner. It is understood that in other embodiments of the centrifugal wheel 1, more than five or fewer than five vanes 4 can be provided. The design of the individual vanes 2, as can be clearly recognized in FIG. 2 in particular, is also purely exemplary. There is a great number of possibilities for the design of the individual vanes 4.

The vanes 2 preferably consist of plastic and can, for example, be designed in one piece with the encapsulation 3. Of course, it is also possible to manufacture the individual vanes 2 or the entirety of the vanes 2 in a separate manufacturing process and then to connect them to the encapsulation 3 of the permanent magnetic core 4, for example by a welding process.

In the embodiment of the centrifugal wheel 1 described here, the permanent magnetic core 4 is designed as a permanent magnetic ring with a central opening 43. In other embodiments, the permanent magnetic core is designed as a permanent magnetic disk.

The “permanent magnetic core” 4 of the centrifugal wheel 1 refers to that area of the centrifugal wheel 1 that cooperates magnetically with the stator 130′ to generate the magnetic levitation forces and the torque.

The permanent magnetic core 4 comprises at least one permanent magnet. Embodiments are also possible in which the permanent magnetic core 4 comprises several permanent magnets 41 (see, for example, FIG. 4). In the embodiment of the centrifugal wheel 1 represented in FIG. 2 and FIG. 3, the permanent magnetic core 4 consists entirely of a permanent magnetic material, so that the permanent magnetic core 4 is the permanent magnet. The permanent magnetic core 4 is magnetized in the radial direction, for example.

Those ferromagnetic or ferrimagnetic materials, which are magnetically hard, that is which have a high coercive field strength, are typically called permanent magnets. The coercive field strength is that magnetic field strength which is required to demagnetize a material. Within the framework of this application, a permanent magnet is understood as a component or a material, which has a coercive field strength, more precisely a coercive field strength of the magnetic polarization, which amounts to more than 10'000 A/m.

Such embodiments are also possible in which the permanent magnetic core 4 of the centrifugal wheel 1 comprises both soft magnetic materials and permanent magnetic materials. FIG. 4 shows a perspective view of such a variant for the embodiment of the permanent magnetic core 4.

The permanent magnetic core 4 comprises a base body 42, at which or in which a plurality of permanent magnets 41 is arranged. The base body 42, which is designed in a ring-shaped manner in the variant represented in FIG. 4, consists of a soft magnetic material, preferably a ferromagnetic or ferrimagnetic material. In particular, iron, nickel-iron, cobalt-iron, silicon-iron or Mu-metal are suitable as soft magnetic materials. The permanent magnetic core 4 further comprises a plurality of permanent magnets 41, here eight permanent magnets 41 in an exemplary manner. Each permanent magnet 41 is designed in the form of a segment. The permanent magnets 41 are arranged radially outwardly along the circumferential surface at the base body 42 and attached to the base body 42, for example by a glued connection. The base body 42 serves as a ring-shaped back iron to conduct the magnetic flux between the permanent magnets 41.

Embodiments of the permanent magnetic core are also possible in which the base body 42 is arranged radially outwardly and surrounds the permanent magnets 41 in the circumferential direction. It is also possible that the base body 42 has recesses into which the permanent magnets 41 are inserted or placed.

Such embodiments, in which the permanent magnetic core 4 does not consist entirely of a permanent magnetic material but, for example, of the ferromagnetic base body 42 and the permanent magnets 41, are advantageous, for example, if one wishes to reduce the costs of large centrifugal wheels 1 by saving permanent magnetic material.

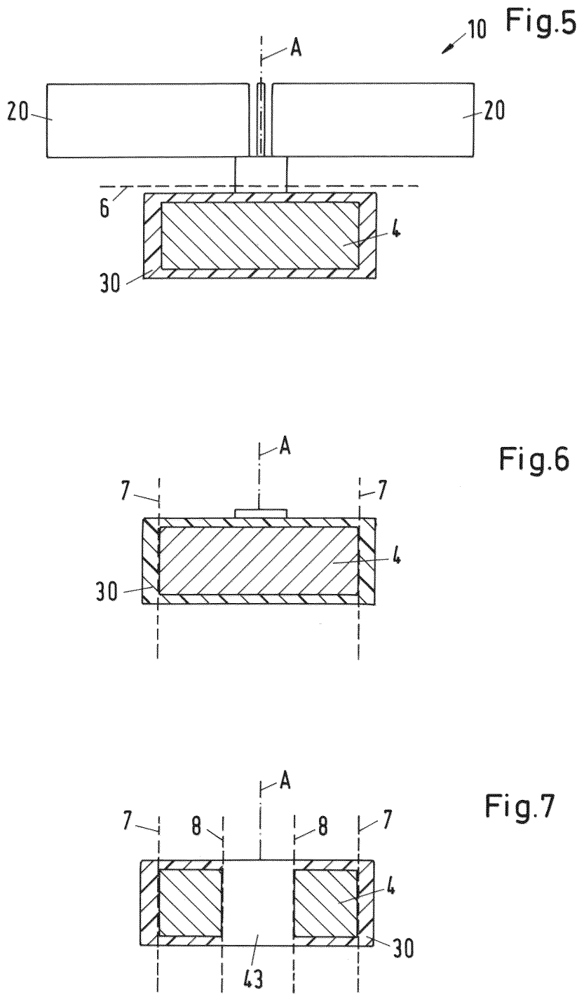

In the following, an embodiment of a method according to the disclosure for manufacturing a centrifugal wheel, for example the centrifugal wheel 1 represented in FIG. 2 and FIG. 3, is explained in more detail on the basis of FIG. 5 to FIG. 7.

First, in a first processing step, an impeller 10 that can be magnetically levitated is provided, which has a permanent magnetic core 4, which is completely enclosed by a sheathing 30, wherein the sheathing 30 consists of a plastic. A plurality of blades 20 for interacting with a fluid or several substances is provided on the sheathing 30. For example, the impeller 10 is the impeller 10 of a pumping device for conveying a fluid or the impeller 10 of a mixing device for mixing at least two flowable substances.

The impeller 10 can also be, in particular, a centrifugal wheel 1′ (FIG. 1) or a centrifugal wheel 1, as described on the basis of FIG. 2 and FIG. 3. In particular, if the impeller 10 is designed for single use, the impeller 10 is preferably a single-use part, for example a centrifugal wheel 1, 1′, which has already been used for an application and must now be replaced by a new, i.e. unused, one.

Thus, the impeller 10 is preferably, but not necessarily, such an impeller that has been designed for single use and has already been used once. Instead of disposing of the complete impeller 10, it is now proposed to separate the permanent magnetic core 4 from the rest of the impeller 10 and then to use the magnetically effective core 4 for the manufacturing of a new centrifugal wheel 1, in particular of such a centrifugal wheel 1 that is designed for single use.

In a schematic sectional view, FIG. 5 shows the impeller 10 which is used for the embodiment described here. After the impeller 10 has been provided, all blades 20 are removed from the sheathing 30 in a next processing step. This can take place, for example, by mechanically removing the blades 20, e.g. by cutting along the dashed line 6 in FIG. 5. FIG. 6 shows the impeller 10 from FIG. 5 after the removal of all blades 20.

In a next processing step, the permanent magnetic core 4 is now separated from the sheathing 30. In FIG. 5 and FIG. 6, the permanent magnetic core 4 is designed as a disk. In a representation analogous to FIG. 6, FIG. 7 shows an embodiment of the magnetically effective core 4 as a ring, i.e. with the central opening 43.

Particularly preferably, the permanent magnetic core 4 is demagnetized before being separated from the sheathing. Particularly preferably, the demagnetization takes place before removing the blades 20 from the sheathing 30. The demagnetization of the permanent magnetic core 4 has the advantage that the further processing, for example the processing with metallic tools and machines, is much easier when the permanent magnetic core 4 is demagnetized. In addition, the risk that impurities are attracted by the permanent magnetic core 4 and accumulate during processing can also be avoided.

The demagnetization of the permanent magnetic core 4 takes preferably place by electromagnetic alternating fields. The process of demagnetization can take place in several steps. The demagnetization is preferably continued until the remanence of the permanent magnetic core disappears or is at least approximately zero. As already mentioned, the term “demagnetization” refers to a reduction of the magnetic moment of the permanent magnetic core 4 to a value which is at most 10% of the magnetic moment which the permanent magnetic core 4 has when fully magnetized.

After the blades 20 have been removed and, optionally, the permanent magnetic core 4 has been demagnetized, the separation of the permanent magnetic core 4 from the sheathing 30 now takes place. There are many ways of doing this, some of which are mentioned below.

In particular, mechanical processing methods are suitable. Thus, for example, the permanent magnetic core 4 can be pressed out of the sheathing 30 by a mechanical pressing device. For this purpose, for example, the sheathing 30 with the core 4 arranged therein is inserted in a mechanical pressing device in such a way that the pressing device exerts a force acting in the axial direction A in particular on the area in which the permanent magnetic core 4 is arranged. This area is indicated in FIG. 6 by the two dashed lines with the reference sign 7. The permanent magnetic core 4 is then pressed by the pressing device along the lines 7 in axial direction A through the sheathing 30 and can be separated in this way from the sheathing 30.

Alternatively or additionally, it is also possible to separate the permanent magnetic core 4 from the sheathing 30 by a machining or chip-removing process. Such mechanical processes comprise, for example, cutting, drilling, sawing, milling, turning or grinding. For example, the sheathing can be cut along the lines 7 or ground or milled away up to the lines 7.

If the permanent magnetic core 4 is designed in a ring-shaped manner and thus has the central opening 43, the separation of the permanent magnetic core 4 takes place preferably in two separate steps. First, a central bore is made along the dashed lines 8 in FIG. 7 to remove the sheathing 30 from the central opening 43 of the permanent magnetic core 4. This bore can be combined with grinding or milling. After the sheathing 30 is removed from the central opening 43—as represented in FIG. 7—the further separation of the permanent magnetic core 4 from the sheathing 30 takes place as described above, i.e. for example by the mechanical pressing device, with which the permanent magnetic core 4 is pressed out of the sheathing 30.

As an alternative to or in combination with the mechanical processing for separating the permanent magnetic core 4 from the sheathing 30, a thermal processing is also possible to separate the permanent magnetic core 4 from the sheathing 30.

For example, the sheathing 30 consisting of a plastic, can be melted by supplying heat so that the permanent magnetic core 4 can be removed from the sheathing 30. However, it is also possible to combine the thermal processing with mechanical processing. For example, the sheathing 30 can be softened or plasticized by supplying heat and then the permanent magnetic core 4 can be pressed out of the sheathing 30 by a mechanical pressing device.

After the permanent magnetic core has been completely separated from the sheathing 30 and optionally cleaned, it serves as the starting component for manufacturing a new centrifugal wheel 1. The completion of the centrifugal wheel 1 can then take place, for example, in an analogously same manner to that used for a new, i.e. previously unused, permanent magnetic core 4.

The permanent magnetic core 4 is provided with the encapsulation 3 (FIG. 2, FIG. 3) made of a plastic, which completely and preferably hermetically encloses the permanent magnetic core 4. Subsequently, the plurality of vanes 2 are attached to the encapsulation 3 and fixed.

There are several processes possible for manufacturing the encapsulation 3. For example, a plastic can be sprayed around the permanent magnetic core 4. This can take place in particular in an injection molding process in an injection molding device.

Particularly preferably, the encapsulation 3 and all vanes 2 are manufactured in a single injection molding process. This means that the encapsulation 3 and all vanes 2 are produced together in a single injection molding process. Of course, it is optionally possible that the final shape of the vanes 2 and/or of the encapsulation 3 is generated after this injection molding process by mechanical finishing, for example by a chip-removing processing.

Furthermore, it is possible to manufacture the encapsulation 3 by joining several components. Thus, the encapsulation 3 can comprise a dimensionally stable cup and a dimensionally stable cover, which is designed to close the cup. The permanent magnetic core 4 is then inserted into the cup, the cover is placed on the cup and then firmly connected to the cup by a joining process. The joining process is, for example, a welding process such as infrared welding. However, the joining can also take place by other methods, for example, by gluing or screwing.

Another possibility is to manufacture the encapsulation 3 by a sintering process. Then, the encapsulation is made of a powder or a granulate that is pressed onto the permanent magnetic core 4 using pressure and, optionally, a temperature processing, in such a way that the permanent magnetic core 4 is completely enclosed. This possibility is also particularly suitable if the plastic of which the encapsulation 3 consists cannot be processed by a an injection molding process, as is the case for polytetrafluoroethylene (PTFE), for example.

After the encapsulation has been completed, the vanes 2 are fixed to the encapsulation 3, for example by welding.

In particular for applications in the pharmaceutical industry or in the biotechnological industry, for example for applications in a bioreactor, biocompatible plastics are preferred for the encapsulation 3 and/or for the vanes 2, in particular polyethylene (PE) or polypropylene (PP).

Of course, other plastics are also suitable, such as polyvinyl chloride (PVC), low-density polyethylene (LDPE), ultra-low-density polyethylene (ULDPE), high-density polyethylene (HDPE), ethylene vinyl acetate (EVA), polyethylene terephthalate (PET), polyvinylidene fluoride (PVDF), acrylonitrile butadiene styrene (ABS), polyacrylic, polycarbonate (PC), polysulfones such as polysulfone (PSU).

If the permanent magnetic core was demagnetized before being separated from the sheathing 30, the permanent magnetic core 4 will be magnetized again after the encapsulation 3 is completed. The magnetization of the permanent magnetic core 4 can take place before or after the vanes 103 are attached.

The method according to the disclosure is particularly suitable, but not only, for such centrifugal wheels 1 which are designed for single use. After the centrifugal wheel 1 has been used, the permanent magnetic core 4 can be separated out and reused for the manufacture of a new centrifugal wheel 1, wherein this new centrifugal wheel 1 is then also for single use.

What is claimed is:

1. A method of manufacturing a centrifugal wheel for a mixing or pumping device with a magnetically levitated centrifugal wheel, comprising:
providing an impeller configured to be magnetically levitated, and having a permanent magnetic core, the permanent magnetic core completely enclosed by a sheathing, the sheathing including plastic, and a plurality of blades to mix or convey substances provided on the sheathing;
removing all blades from the sheathing;
separating the permanent magnetic core from the sheathing, the permanent magnetic core being demagnetized before the permanent magnetic core is separated from the sheathing;
attaching an encapsulation including plastic, and which completely encloses the permanent magnetic core; and
attaching a plurality of vanes to the encapsulation.

2. The method according to claim 1, wherein the permanent magnetic core is magnetized after the attachment of the encapsulation.

3. The method according to claim 1, wherein the separation of the permanent magnetic core from the sheathing takes place by a mechanical processing.

4. The method according to claim 3, wherein the mechanical processing comprises cutting or drilling or grinding or milling.

5. The method according to claim 1, wherein the separation of the permanent magnetic core from the sheathing takes place by a mechanical pressing device.

6. The method according to claim 1, wherein a central bore separates the permanent magnetic core from the sheathing, the central bore extending completely through the sheathing in an axial direction.

7. The method according to claim 1, furthering comprising supplying heat to the sheathing to separate the permanent magnetic core from the sheathing.

8. The method according to claim 1, wherein the encapsulation is manufactured by spraying a plastic around the permanent magnetic core.

9. The method according to claim 1, wherein the encapsulation and the vanes are manufactured in a single injection molding process.

10. The method according to claim 7, wherein the encapsulation is manufactured by joining several components.

11. The method according to claim 9, wherein the encapsulation comprises a cup and a cover, the permanent magnetic core is inserted into the cup, and the cover is welded to the cup.

12. The method according to claim 7, wherein the encapsulation is manufactured by a sintering process.

13. The method according to claim 1, wherein the encapsulation and the vanes include a biocompatible plastic.

14, The method according to claim 1, wherein the encapsulation and the vanes include polyethylene or polypropylene.
